(19) United States
(12) Patent Application Publication
(10) Pub. No.: US 2005/0216416 A1
(43) Pub. Date: Sep. 29, 2005

(54) Business method for the determination of the best known value and best known value available for security and customer information as applied to reference data

(76) Inventors: Carl Abrams, Briarcliffe Manor, NY (US); Cornelius E. Crowley, Morristown, NJ (US); Francis Nicholas Parr, New York, NY (US); Teresa Glassser, New York, NY (US); Sugandh Mehta, Wayne, NJ (US); Guerney Douglass Holloway Hunt, Yorktown Heights, NY (US); Max Hrabrov, Brooklyn, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/810,667

(22) Filed: Mar. 29, 2004

(51) Int. Cl. H04K 1/00; G06F 17/60

(52) U.S. Cl. 705/52; 705/35

(57) ABSTRACT

A business method allows a reference data facility to provide high quality reference data to multiple customers. The reference data service is predicated on establishing independent contractual arrangements or subscriptions between multiple customers and multiple data vendors. The reference data facility receives value streams from the multiple data vendors and delivers reference data based on those value streams to the multiple customers, depending on the independent contractual arrangements or subscriptions that entitle the customers to receive values from some subset of the data vendors. The reference data facility insures that no customer receives data or benefits from the knowledge of data content from a vendor with whom they do not have a contractual arrangement or to whose data they are otherwise not entitled.

### BACKGROUND OF THE INVENTION

1. Field of the Invention

The present invention relates generally to the area of data identification and quality assurance processing as it applies to a Reference Data Facility (RDF) for capital markets securities and customer information.

2. Background Description

The Financial Services Industry depends on the timely valuation, risk analysis, trading, clearance and settlement of a multitude of financial instruments. The instruments range from government securities, to exotic derivatives. Through a desire to be more efficient, reduce cost and manage risk, the industry is moving deliberately toward complete automation of trading, clearance and settlement, and management reporting. Initiatives that support the drive to shorter settlement cycles and the ability to monitor and manage risk on a real time basis have gained momentum both in the United Sates and around the world.

One of the critical means for financial services firms to achieve these ends is for the information that describes the securities, trading counterparties, and institutional customers to be accurate, consistent and available to each firm involved in the trade. This information is known as Reference Data. It is the detailed descriptive information for financial instruments, the parties who trade them, and the companies who issue them. Reference Data provides the foundation for all securities processing and management reporting.

Historically, firms have each built and maintained their own stores of Reference Data in isolation from other firms. Financial instrument descriptions and associated data are generally stored in databases referred to as the Product of Security Master File. Trading counterparty and customer data (including legal entity hierarchies) are generally stored in a database referred to variously as the Party, Counterparty, Account or Customer Master File. Corporate Actions can impact both instrument and customer databases and their notifications are generally stored in related database systems.

The Security and Customer master files are similar in nature and content across firms. They are typically maintained through a combination of automated data feeds from external vendors, internal applications, and manual entries and adjustments.

The information contained and replicated in the databases has three components. The first is information generated by any one of a number of data vendors specializing in financial data capture. Firms needing reference data typically contract with a number of these data vendors and pay licensing fees for access to the vendor's product. The second component is data in the public domain, i.e., from publicly available, original source documentation (in both paper and electronic form), which can be acquired and used to augment or validate the vendor's proprietary data. The third component is data that is manufactured internally and is distinct to each firm.

The information in the databases is subject to each firm's own quality assurance processing. This processing is necessary to ensure the accuracy of the data according to each firm's standards. However, firms have different standards of quality and the business and technology infrastructure to support reference data is often duplicated many times worldwide by each firm and by multiple departments within each firm. This has led to increased costs and operational inefficiency in the acquisition and maintenance of reference data.

FIG. 1 illustrates the internal problem. Redundant purchases and validation, different formats/tools, inconsistent formats/standards/data, and difficulties in changing and/or managing vendors all contribute to inefficiencies. As an industry, inconsistent levels of quality and lack of standards reduces the efficiency and accuracy of communications between firms, resulting in increased cost and higher levels of risk. The industry problem is illustrated in FIG. 2. There are few standards for the data or comparing common data between members, and there are inefficient operations and trade failures attributed to inconsistent and low quality data.

Firms would benefit greatly by having access to a Reference Data Facility (RDF) that provides a single standard of quality for data that is delivered to each firm. The content of the RDF would be supplied by the data vendors to which each customer firm subscribes, augmented with publicly-available data. The RDF would allow the cross-checking and validation of data from multiple sources to determine a “best known value”. The RDF would provide a service to each customer delivering the “best known value” they are entitled to receive. This facility would enable customers to:
reduce the cost and improve the quality of their reference data management,
more reliably measure risk,
reduce trade breaks and operational risk,
add new securities more rapidly,
improve their ability to more rapidly meet emerging regulatory requirements (e.g. Basel II, Patriot Act),
address cost transparency, and
improve contract administration and vendor control.

### SUMMARY OF THE INVENTION

It is therefore an object of the present invention to enable a Reference Data Facility (RDF) for capital markets securities and customer information.

A key challenge for the RDF is to ensure that no customer is aware of, has access to, or otherwise benefits from vendor data content to which the customer has not subscribed even though these feeds reside in the RDF. At the same time, the RDF must not only deliver to each customer the stream of “best known values” to which they are entitled, but also reduce costs by achieving economies of scale in the acquisition and quality assurance processing of vendor-supplied and publicly-available data. The key to achieving these goals is a three-step process for the value of each Reference Data entity:
(1) validating and normalizing the candidate data for that entity in each vendor stream,
(2) determining a Best Known Value (BKV) for the entity based on all vendor-supplied and publicly-available data, and
(3) for each customer of the RDF, determining and delivering the Best Known Value Available (BKVA) to each customer, based on the customer's vendor subscription entitlements.

The determination of the BKVA for the customer must be accomplished without knowledge of the data supplied by vendors to which the customer does not subscribe. The definitions for BKV and BKVA and the processing method on which they are built are the subject invention, making this efficient and cost-effective three-step quality assurance processing for Reference Data feasible.

In general, selection of the BKV is based on a combination of understanding the business, the underlying financial instruments or customer structures, the vendors and their areas of specialization, client use, and experience with reference data validation. The invention describes the algorithms and process for determining both the BKV and BKVA in a Solution that allows for economies of scale in the quality assurance processing of vendor data in a shared facility.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the internal reference data problem addressed by this invention;

FIG. 2 is a block diagram illustrating the overall industry problem addressed by this invention;

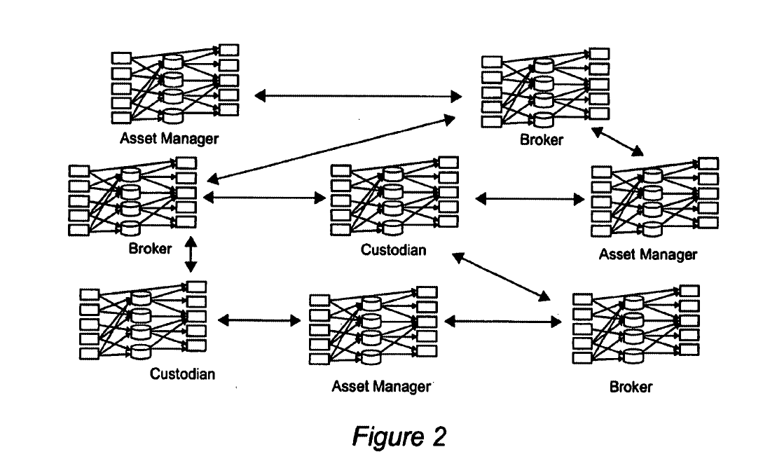

FIG. 3 is a graphical illustration of an example computation of Best Known Value (BKV) and Best Known Value Available (BKVA) to specific customers according to the present invention;

FIG. 4 is a flow chart showing how data acquired from data vendors is first subject to quality assurance processing, goes through Best Known Value selection then is stored in the reference data store according to the invention; and

FIG. 5 is a flow chart showing the steps in computing Best Known Value Available for each customer and in delivering data to customers from the reference data store according to the invention.

### DETAILED DESCRIPTION OF A PREFERRED EMBODIMENT OF THE INVENTION

### Best Known Value, BKV, and Supporting Concepts

BKV is a logical concept available for use within the RDF but not in general a service deliverable to customers directly. A base set of streams of data is available to the RDF. These include vendor-supplied data purchased by the RDF customers, data purchased directly by the RDF, and data that is publicly available. At each point in time, whenever a new item of reference data arrives in one of the base streams for a logical reference entity, a decision is made for the entity as to which of the recently arrived values in the different streams is the Best Known Value (BKV). Oftentimes, there is no single “correct” data value or a single data value may be subject to differences in interpretation at different points in time. The BKV is the “best” currently known value for that entity given all the information available to the RDF and whose selection from among competing values is based on the business expertise of the RDF staff.

The BKV corresponds either to one of the values supplied by one of the vendor streams or an RDF-owned or publicly-available value distributable to all clients who have signed up with the RDF for the BKVA service.

### Best Known Value Available to Customer C₁, BKVA[C₁]

Best Known Value Available (BKVA) is a service delivered directly to customers of the RDF. Different customers may receive different BKVA values for the same reference entity at any one time. Concepts used in defining BKVA[C₁] include:
V[C₁]—the subscription set of vendors to which customer C₁ has subscribed, including publicly-available data and data purchased or computed by the RDF,
D[C₁]—the default rule provided by C₁ for providing a value based on V[C₁], and
H(e₁, t₁)—the hit set of vendors whose latest quality-assured value for (e₁, t₁) matches BKV(e₁, t₁).

Formally, BKVA[C₁](e₁, t₁)=BKV(e₁, t₁) if H(e₁, t₁) intersects V[C₁] non-trivially AND D[C₁] (e₁, t₁) otherwise.

Each customer for BKVA is required to:
register with the RDF—exactly which vendor data streams it is entitled to receive
   Let V[C₁] be the subscription set for customer C₁.
provide a customer specific algorithm D[C₁]—“the default rule”—which in all circumstances will generate a value which that customer C₁ is entitled to receive for any reference entity whose value customer C₁ can request
   Typical default rules might be: “always use vendor V₁'s value” or “use vendor V₁'s latest value on equities but V₂'s latest value on corporate bonds”—where customer C₁ must be subscribed to V₁ and V₂.
   We use the notation D[C₁](e₁, t₁) to represent C₁'s default rule being used to generate a value for reference entity e₁ at time t₁.
   In general, different customers will be subscribed to different subsets of vendors used by the RDF and hence have different default rules.

The BKVA service for a customer C₁ is then determined as follows:
Assume that vendor streams V₁, V₂, V₃ . . . Vₙ are in use by the RDF.
   Publicly available data and data purchased by the RDF can be treated in the same manner as additional vendor streams.
For reference entity e₁, at time t₁, the RDF may select a particular value BKV(e₁, t₁) from the available stream values based on business expertise but NOT consensus—as described in the definition of BKV above.
BKV (e₁, t₁) will always agree with at least one of V₁(e₁, t₁), V₁(e₁, t₁), . . . V₁(e₁, t₁).
   In general, there will be a “hit set” of vendors whose most recent quality-assured value for (e₁, t₁) agrees with the BKV for (e₁, t₁).
   Let H(e₁, t₁)={Vᵢ: Vᵢ(e₁, t₁)=BKV(e₁, t₁)} be the hit set.
BKVA[C₁](e₁, t₁) is, by definition, the best known value for e₁ at time t₁ which can be made available to customer C₁.
   If H(e₁,t₁) includes at least one vendor in V[C₁], the set of vendors to which customer C₁ subscribes, i.e., the subscription set, then BKVA[C₁](e₁, t₁)=BKV(e₁, t₁), i.e., the “best known value” is delivered to customer C₁.
   If customer C₁ has not subscribed to any of the vendors in H(e₁, t₁), then customer C₁ cannot receive the BKV; instead customer C₁ will receive the value generated by its default rule:
      BKVA[C₁](e₁, t₁)=D[C₁](e₁, t₁).

### Information Hiding Aspects of BKVA

A BKV/BKVA system does not provide information to a customer about the specific values a vendor has provided, for reference entity e₁ at time t₁, unless the customer is entitled to receive the vendor's information. In general, it is not the intention of the RDF to disclose to customers the fact that data vendors to which customer C₁ does not subscribe have provided values for (e₁, t₁) which differ from BKVA[C₁](e₁, t₁). More specifically, the RDF does not disclose to customer C₁ whether, for a particular entity e₁ at a particular time t₁, the BKVA(e₁, t₁) was generated by the default rule D[C₁](e₁, t₁).

To support this principle, the following properties apply to the customer default rules D[C₁]:
D[C₁] must return a unique value D[C₁](e₁, t₁) for each reference entity e₁ at all times t₁, and
that value D[C₁](e₁, t₁) must be in agreement with the “latest quality assured value for e₁” in at least one of the vendor streams Vₓ in V[C₁], i.e., subscribed to by customer C₁.

This disqualifies default rules of the form “add 0.1 to V₁'s value” or, more realistically “take the average over the quality-assured values provided by vendors in V[C₁]”. This does not prevent the RDF facility from computing average over quality-assured values from V[C₁] as a service for customer C₁. However, this function will be provided separately and is not intended to be used as the default rule for customer C₁'s BKVA service. The BKVA service will provide more accurate values than simple averaging because it incorporates additional business expertise provided by the RDF not embedded in a simple averaging function.

### Releasing the Associated Source References for Hit Sets H(e₁, t₁) and H[C₁](e₁, t₁)

Typically, when the RDF releases a value for a reference entity e₁, it will be able to provide a reference to the source data from which this BKV is derived. If several vendors concurred on a value for e₁ which was being recommended as the BKV, the RDF will not identify a particular vendor stream as the source. Doing so would not be fair or acceptable to the vendor providers. Logically, if customer C₁ had subscribed to V[C₁] and on a particular entity-time pair (e₁, t₁) customer C₁ receives the BKV(e₁, t₁), then there is at least one vendor Vₓ and a particular source data record V₁(i) from Vₓ whose quality assured value matched BKV(e₁, t₁). Customer C₁ should have the option to receive as supporting reference information the i value—sequence number or timestamp—uniquely identifying the “correct” source data from this vendor, and should receive that from each vendor in V[C₁]:

If BKVA[C₁](e₁, t₁)=BKV(e₁, t₁),
Then for each Vₓ in the intersection of H(e₁, t₁) and V[C₁], C₁ will receive the sequence number i of the source record from Vₓ whose quality assured value was the same as BKV(e₁, t₁).

In instances where customer C₁ receives a default rule value rather than the BKV, a different source reference computation is required, based on the vendors and records matching the default rule value delivered to customer C₁:

If BKVA[C₁](e₁, t₁)=D[C₁](e₁, t₁),
Then let H[C₁](e₁, t₁) be the set of vendors Vₓ in V[C₁] whose quality assured values for entity e₁ at time t₁ match D[C₁](e₁, t₁); for each of these vendors there is a source record whose quality assured value matched D[C₁](e₁, t₁).
For each Vₓ in H[C₁](e₁, t₁), C₁ will receive the sequence number i of the source record from vendor Vx whose quality assured value was the same as D[C₁](e₁, t₁).

Notice that with available hit set H[C₁](e₁, t₁) defined in this way, customer C₁ can be given full source reference information with every BKVA value returned and still have complete information hiding. C₁ could compare BKVA[C₁](e₁, t₁) with Vₓ(e₁, t₁) for each of the streams in V[C₁]—since customer C₁ is entitled to receive quality-assured values for those streams. Customer C₁ will see that a valid H[C₁](e₁, t₁) is being returned and validate that this includes correct source reference information without knowing whether the BKVA[C₁](e₁, t₁) value is actually BKV(e₁, t₁) or not when BKV(e₁, t₁) has been supplied by a vendor to which customer C₁ does not subscribe; hence information hiding is preserved.

If the RDF were to take the business decision to provide only the BKVA[C₁](e₁, t₁) and offer no explicit support for source reference information, the customer could search the vendor streams to which they had access, create H[C₁](e₁, t₁) on their own, and determine which of the vendors provided a matching value. Information hiding would be preserved as long as the customer has access only to the data that they have purchased. This shows that the RDF could provide the full definition of H[C₁](e₁, t₁) to customers as an additional service without violating informational hiding.

### Default Rules for BKVA and a Reference Domain Partitioning

The RFD will provide a partitioning of the reference domain which is to be used:
as part of the normalized data model for reference data,
as both an aid and a constraint on customer default rules for BKVA,
as the basis for reporting statistics on vendor stream accuracy, and
as a basis for selling customers different combinations of the BKVA services.

One form of domain partitioning is the classification of assets according to industry-, vendor-, or client-defined standards.

We have already mentioned that a default rule that customer C1 might provide in order to get BKVA service is to use Vₓ's values for equities and V_{y}'s values for corporate bonds. Now rather than have each customer C₁ define its own partitioning of the reference domain (i.e., the set of entities e₁ on which reference values are being provided), it may be better for RDF to define its partitioning which all customers are then required to use when they define default BKVA rules D[C₁].

This RDF-provided partitioning should be sufficiently coarse that it prevents overly complex customer default rules—we do not want to encourage customers to ask for Vₓ values on vendor X but V_{y} values on vendor Y as their default rule. However, it should be sufficiently fine-grained to support most subset services offered by data vendors. If some customers can buy V₁ government bonds, but not pay for V₁ equities information, they are likely to want a default rule which uses V₁ as a source on government bonds, but prefers some other source on equities. Since there are multiple data vendors each with potentially different subsets of data which they market, the domain partitioning will need to be fine enough to reflect all important subsets of data offered as options by the vendors.

The partitioning provided by RDF should clearly be consistent with the data normalization processes and the code data models used within the RDF for BKVs.

The default rules for customer C₁ getting BKVA service should then take the following form:
1. Customer C₁ provides a partition P[C₁] which is a “simplification” of the domain partitioning defined by RDF
   i.e., P[C₁] is a set of disjoint subsets P[C₁], P₂[C₁], P₂ [C₁] of the reference domain such that each partition Pₓ[C₁] is just a union of smaller subsets defined in the RFD base partitioning
2. Customer C₁'s default rule is defined by specifying the priority to be applied to vendor streams within each partition in P[C₁]
   i.e., in each partition Pᵢ[C₁], there is a priority defined by customer C₁ on vendors, e.g., V₁, V₂, V₃, . . .
   If entity e₁ belongs to P₁[C₁], the default is to use the latest V₁(e₁) value; unless that is either not available or older than some designated life in which case the V₂(e₁) value is used, etc.
   The assumption in the above is that for entities in partition P₁[C₁], customer C₁ must be subscribed to receive values from all vendor streams in its priority list for that partition.

### Implementation

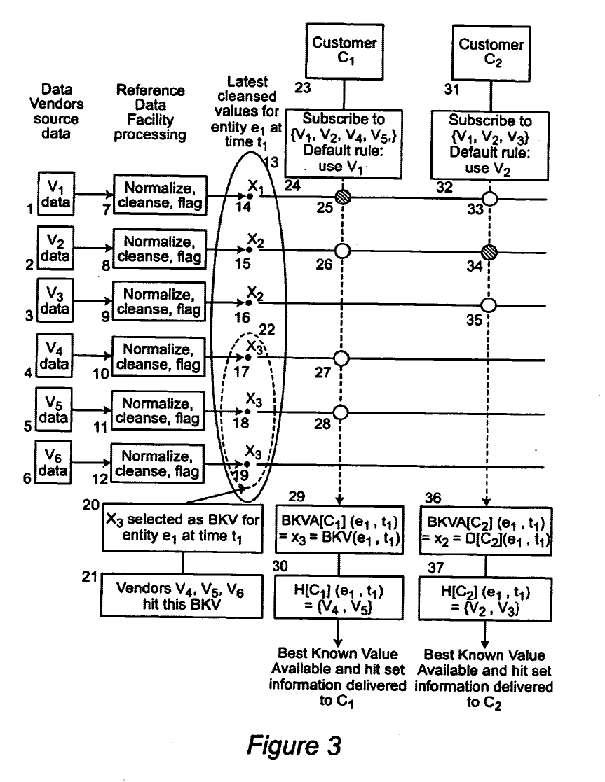

Referring now to the drawings, FIG. 3 illustrates and explains the core concepts of BKV and BKVA with a diagram detailing computation for a particular example. In this example, vendors V₁, V₂, V₃, V₄, V₅, and V₆ supply data for the reference entity. Each vendor maintains separate contracts with customers of the RDF. In the figure, Boxes 1, 2, 3, 4, 5, and 6 represent these vendors and the streams of data which they supply. Boxes 7, 8, 9, 10, 11, and 12 represent the quality assurance processing done on each of these steams independently within the RDF. Oval 13 represents the set of latest quality-assured values available at time t₁ from each of the data vendors for reference entity e₁. Items 14, 15, 16, 17, 18, and 19 represent the quality-assured values from vendors V₁ through V₆, respectively. Vendors V₄, V₅, and V₆ are all proposing the value X₃, vendors V₂ and V₃ suggest the value x₂, and vendor V₁, recommends x₁, as the correct value for e₁. Box 20 represents the RDF processing to select a BKV for entity e₁. The BKV selected from among all the available values in ellipse 13 is x₃. The subset of vendor values which match this BKV for (e₁, t₁₀) is marked with the dashed ellipse 22. Box 21 represents the processing in the RDF to compute the hit set H(e₁, t₁) of vendors delivering a value which matches the selected BKV.

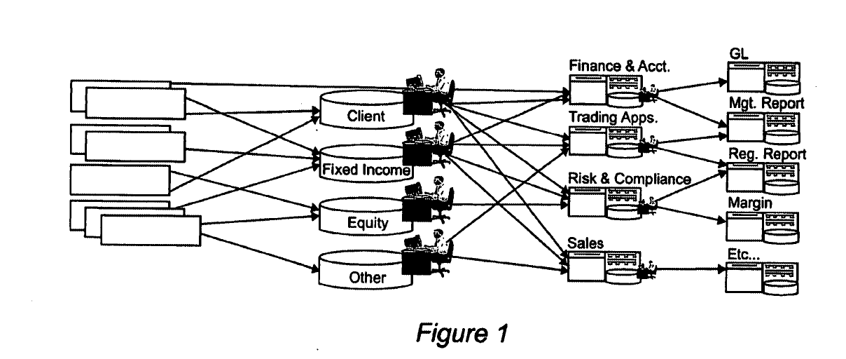

The remainder of FIG. 3 characterizes the computation of BKVA data and associated hit set information which can be delivered to two customers, C₁ and C₂. The vertical line headed by Box 23 characterizes this computation for customer C₁. Box 24 states the profile information characterizing this customer for the purposes of the BKVA computation in this example. Customer C₁ has subscriptions to data from vendors V₁, V₂, V₄ and V₅. Customer C₁'s default algorithm will be used to supply a legitimate value when customer C₁ is not eligible to receive the BKV. In this example customer C₁'s default rule is to take the most recent quality-assured value from vendor V₁. This set of properties of customer C₁ is expressed in FIG. 1 as the circles 25, 26, 27, 28 and the “C₁ access line” running through them. These circles lie on a vertical “access line” for customer C₁ and show that this access line intersects with the lines representing the data stream from vendors V₁, V2, V4 and V5, denoting customer C₁'s access to these streams of vendor data. The shaded circle 25 denotes the special status of the access to vendor V₁ data; that it is used as the source for default values when customer C₁ is not eligible to receive the BKV.

Box 29 spells out the computation of BKVA delivered to customer C₁ given the BKV set of vendor hits and customer subscriptions. Customer C₁ can receive the BKV because it is entitled to receive values from V₄ and V₅, which are both in the hit set for (e₁, t₁). Box 30 shows the hit set information delivered to customer C₁ specifically that V₄ and V₅ are both valid sources for the value x₃ delivered to customer C₁ as the BKVA for entity e₁ at time t₁.

The vertical line headed by Box 31 shows the BKVA and hit set computation for a contrasting customer C₂. It follows the same notational conventions as used for the previous customer C₁ in the vertical line headed by Box 23. Box 32 states that customer C₂ is licensed to receive data from vendors V₁, V₂ and V₃ only, and that customer C₂'s default rule to be used when not eligible to receive the BKV is to take the most recent quality-assured value from vendor V₂. Circles 33, 34 and 35 denote this graphically by showing the vertical “access line” on which they lie intersecting with vendor lines for vendors V₁, V₂ and V₃. The intersection of customer C₂'s access line with vendor V₂'s data line is marked with a shaded circle identifying the vendor V₂ stream as the source of default values when customer C₂ is not eligible to receive the BKV.

Box 36 then spells out the actual computation of BKVA for customer C₂ for entity e₁ at time t₁. Since customer C₂ does not subscribe to any of the vendors providing the BKV, x₃, it cannot receive this value for e₁. Hence, BKVA[C₂](e₁, t₁) the value delivered to customer C₂ for this entity must be based on customer C₂'s default algorithm, i.e., take the latest quality-assured value from the default stream specified in the default algorithm. Hence, in this example, customer C₂ will receive the value x₂ for entity e₁, as BKVA. Box 37 shows this value is supported with a hit set report identifying the vendors to which customer C₂ has access and who were sources for that BKVA. The hit set information delivered to customer C₂, H[C₂](e₁, t₁) relating to entity e₁ at time t₁ is that both vendors V₂ and V₃ were sources for the delivered BKVA value x₂.

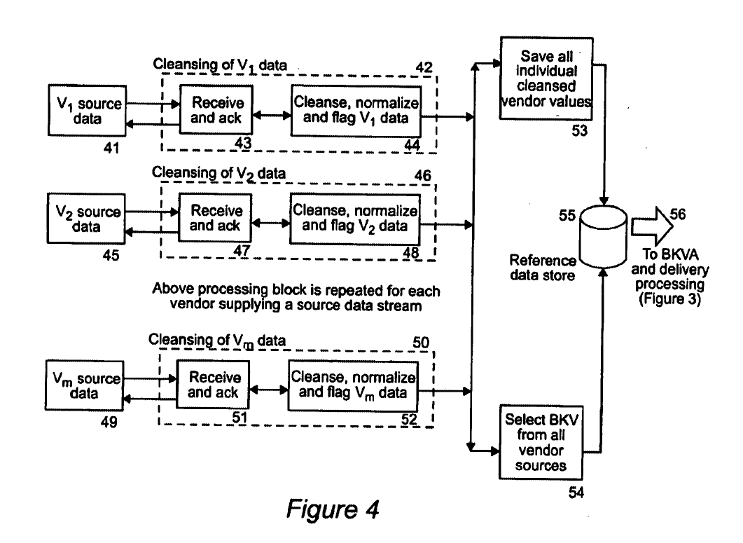

FIG. 4 shows the Process Flow for the input side of the BKV and BKVA processing. This flow chart describes the input side of the BKV and BKVA processing where data is provided by a variable number of vendors, each with their own contracts with customers. Boxes 41, 45 and 49 represent data vendors V₁, V₂, and Vₘ respectively. The acquired data from each data vendor is processed independently, but with a similar approach, as is illustrated by dashed Boxes 42, 46 and 50. Box 43 shows that data acquired from vendor V₁ is received and acknowledged. Box 44 shows that this data then goes through the quality assurance process. Any data item which fails any of the quality assurance checks, or results in exception during the acquisition process will be identified as questionable and subject to further verification. A typical corrective action would be to use the bidirectional path, back through Box 43 and out to the vendor V₁(Box 41) to request that corrected source data be supplied. These quality assurance processing steps are carried out independently for each of the data vendors. This is illustrated in FIG. 4 by Boxes 47 and 48 which provide the internal details for acquisition and quality assurance processing of data from vendor V₂, and Boxes 51 and 52, which provide the internal details for the quality assurance processing of data acquired from an additional generic vendor Vₘ.

After the vendor-specific quality assurance processing is completed for each vendor (dashed Boxes 42, 46 and 50), the resulting values for each entity are stored in the reference data environment—element 55. The processing for this is shown as Box 53.

The processing to select a current BKV at each time for each reference data entity is shown in Box 54. As each new entity value appears from a quality assurance-processed vendor stream, a comparison is made with quality assurance-processed values from all other vendors for that entity (these will be available in the reference data environment—element 56) and a decision made whether the new vendor value should become the BKV for that entity at this time. The selection of a BKV may sometimes be automatic (this would be the case for example if all quality assurance-processed vendor streams providing a value for this entity were in exact agreement on the value) and may sometimes require manual selection based on business expertise. The BKV selection is a decision made on the basis of the latest quality assured values available from all of the vendors supplying data to the RDF. It is not necessary to compute a BKV for each combination of source vendor streams. (Although, a service is contemplated whereby BKVs based on a specific subsets of the vendors is computed.) The BKV is stored in the RDF environment together with the identification of the vendors whose data contributes a matching value. When the BKV is the result of manual entry, the data will be identified as such and the source identified and recorded. Self-learning tools can be incorporated that allow the development of new validation routines, methods, and behaviors to increase the efficiency.

Hence, the reference data environment contains at all times: the BKV, the BKV hit set with references for all reference entities, and the latest quality assured value for each entity from each data vendor. The RDF may also be used as a repository for historical data and as the platform for the development of additional reference data products and analytical tools.

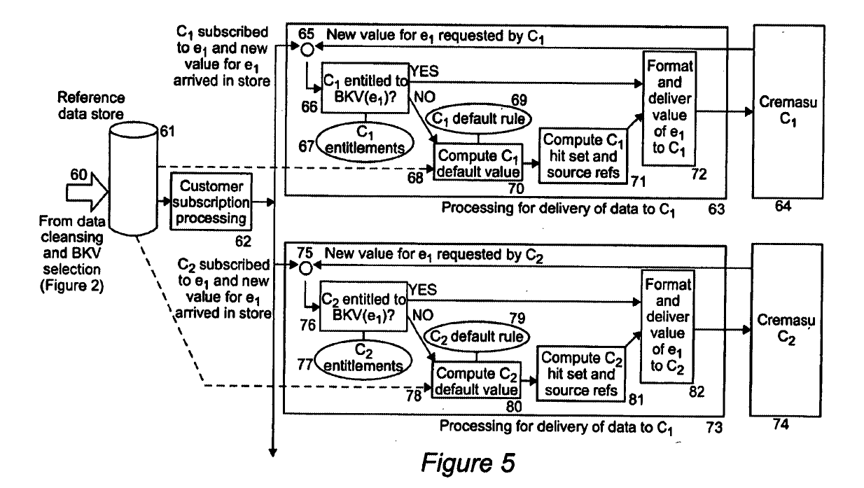

Arrow 56 is the starting point for output processing, determining the BKVA for each customer. This process is described in FIG. 5 below.

FIG. 5 shows the Process flow for BKVA processing and customer delivery. FIG. 5 describes the output processing for quality assured data and BKV values after their processing and storage in the RDF, the determination of the BKVA for each customer, and final delivery to the customer.

Arrow 60 makes clear that this is the second part of an overall process. The reference data store (element 61) has been populated with quality assured data and BKVs following the processing described in FIG. 4.

The flow in this figure is designed to address the issue that there is a variable and potentially large number of customers each of which may have different contractual arrangements with the data vendors and must not be given any access to values to which they are not entitled. Typically, each customer will subscribe to some proper subset of the vendors whose data is processed in this facility and who may provide the BKV for an entity at some point in time. We have only shown two customers C₁ and C₂, for the example in this figure, represented by Boxes 64 and 74. The processing in the RDF needed to support valid deliveries of reference data to customer C₁ is shown in Box 63, that to support valid deliveries of reference data to customer C₂ is shown in Box 73. In general, there will be many customers repeating this pattern, each requiring their own independent delivery processing block. The term “customer” is defined as a single logical customer as perceived by the RDF, although there may be several “customers” within a given institution. If there were two departments or separate business applications in a single institution, each interested in different data with potentially different formats, and if these departments could have independent contracts with data vendors, then these applications or departments would be considered separate customers in the terms of this description.

Box 62 represents subscription processing. This determines which customers receive what data. For example, a customer department or application dealing exclusively with corporate bonds will have little interest in receiving reference values for equities. Typically, Box 62 works by having each customer supply, in its profile, subscription information defining the entities for which they would like to receive reference information. As each new item of reference data is made available (element 61), it is matched against the customer subscriptions in Box 62 to determine which customers are eligible to receive this new value. Each new data item is made available so that the customer-specific delivery processing Boxes 63 and 73 can determine whether the customer is entitled to receive this new value and if so how it should be transformed and delivered.

A detailed description of the customer-specific delivery processing is provided for customer C₁ involving elements 65-72, which are the contents of Box 63. The customer-specific processing for customer C₂ involving elements 75-82, inside Box 73, is an independent but exactly parallel flow. Additional customers would each have an additional independent instance of this flow.

Element 65 is the starting point indicating that a new reference entity value is to be delivered to customer C₁. This could be triggered either by a push flow (a new entity value has arrived) or a pull flow (a request for the data has been received). Customer C₁'s subscription matched this entity during the subscription processing, in Box 62, showing that customer C₂ is interested in the value of this entity. The push triggering delivery processing for customer C₁ is illustrated by the arrow from Box 62 to Element 65. Alternatively, customer C₁ may have requested a reference value for this entity, e₁, to meet some specific business need. This is represented by the arrow directly from Box 64, the customer C₁, to element 65, the start element for customer C₁-specific delivery processing.

The customer-specific delivery processing assumes that the current value of reference entity e₁ is of interest to customer C₁. The first step, Box 66, is to determine whether customer C₁ is entitled to receive the BKV for e₁, BKV(e₁). This decision is based on the hit set and customer C₁'s contracts with the data vendors, stored as state information and shown as element 67. If customer C₁ is entitled to receive BKV(e₁), no further data gathering is needed, this value for e₁ can be made available to customer C₁ as BKVA[C₁](e₁) and formatting and delivery of this result can proceed immediately, as shown in Box 72. If customer C₁ is not entitled to receive data from any of the vendors providing BKV(e₁), then customer C₁'s default rule, element 69, is applied in a processing step, element 70, to quality-assured values for e₁ that customer C₁ is entitled to receive. These values are available in the reference data store and the implied retrieval is shown by the dashed arrow 68. The result of the default value computation is a different value for e₁ which can be delivered to customer C₁ as BKVA[C₁](e₁).

Regardless of whether a BKV or a default rule was used to provide the BKVA for e₁ for customer C₁, final data formatting and delivery is provided in a step shown as Box 72. This step allows transformation of the data, use of a delivery protocol, and scheduling as specified by customer C₁ to meet their needs.

The logic of the delivery processing has been described in terms of a single value being provided. The same logic and flow could be used with any batching and scheduling scheme. This could range from a daily refresh of reference values at a scheduled time, to a real-time mode where single entity values or small sets of them are delivered as soon as they become available in the RDF.

In summary, the business method according to the invention allows a Reference Data Facility (RDF) to provide high quality reference data to multiple customers based on values received from multiple data vendors. The RDF delivers these reference values to multiple customers, each with independent contractual arrangements or subscriptions that entitle them to receive values from some subset of the data vendors in such a way that no customer receives data or benefits from the knowledge of data content from a vendor with whom they do not have a contractual arrangement or to whose data they are otherwise not entitled. The RDF has sufficient flexibility so that all customers are not required to subscribe to the same set of data vendors. Moreover, the RDF does not have to independently compute the Best Known Value Available (BKVA) for every possible combination of data vendors to which the customer could subscribe. Without this property, the cost of providing reference data will be combinatorial in the number of possible data vendors and hence cannot be supplied economically as a utility service made available to multiple customers. The RDF has the ability to offer its customers the option to compute the BKVA for specified subsets of the data vendors supplying data to the Reference Data Facility and to which the customer subscribes. Customers can specify rules for sub-setting, filtering, and transforming data to be delivered to them. In addition, customer specific data formatting, delivery scheduling, filtering, routing and protocol requirements can be provided as part of the process of delivering the reference values.

Each value stream received from a data vendor by the RDF is individually checked and improved by automatic or manual data validation and completeness, range, volatility, and similar checks as well as validation with respect to publicly available information, original source documents, notifications, news events and other available information to improve the quality of this stream. Each value stream received from a data vendor may be normalized by some combination of automatic and manual processing to allow comparison with corresponding values from other data vendors and storage in a database of reference values.

The RDF providing the high quality reference data service does not have to generate data itself but adds to the quality of the data provided by source data vendors. The RDF does this through a combination of returning suggestions for data correction to the data vendors and also by selecting for each customer a recommended value (the BKVA to that customer) from among the values provided by the data vendors. The RDF provides the high quality reference data service by providing the added service of correcting data it determines to be in error and sending this data to its customers as well as reporting the corrections vendors providing incorrect data. Both corrected and uncorrected data can be made available to customers who subscribe to the vendors' data. Historical data received from vendors can also be made available to customers in both corrected and uncorrected form.

The RDF maintains a persistent reference data store in which quality-assured reference values from each data vendor are stored along with information private to the RDF about the ideal value—Best Known Value (BKV) for each reference entity at each point in time. The historical BKV is retained and made available to customers by the RDF. In addition, a customer's historical BKVA can be derived and made available to the customers. Also, in the above method, customers never receive information to which they are not entitled from the reference data facility, because reference values are delivered to them in a way which hides whether the delivered value is the best value currently known to the reference data service or some other value acceptable to the customer based on information to which the customer is entitled.

The value of reference data delivered to a customer can be further enhanced by flagging the values as delivered to denote such conditions, questionable value undergoing further validation, no reliable value available, etc. Each reference entity value delivered to a customer can be annotated with full source information specifying which original data records from which vendors (available to that customer) are valid entitled sources of the provided value. The reference data can be applied to the reference domains of financial instrument data (e.g., asset class definitions and instrument specifications), counterparty information, legal entity hierarchies, customer master files, and corporate actions. Moreover, customers can define customer-specific algorithms, which in all circumstances will generate a value which that customer is entitled to receive for any reference entity whose value the customer can request. Such customer-specific algorithms are segregated by customer.

In the practice of the invention, there is flexibility to accommodate data vendors who license different subsets of their data to different customers by providing a simple partitioning of the reference entities to help customers express which source they would prefer to use from among the quality-assured vendor data streams to which they are entitled for each reference entity.

Periodic objective and data vendor neutral reports can be provided to customers regarding the accuracy of the vendors for each category of reference data as identified in the partitioning.

The reference data service according to the invention may be provided globally, using multiple delivery points, manual expertise in reference data quality assurance at different geographic locations, and high availability through the use of multiple geographically dispersed locations and time zones for the reference data service and its reference data stores. Auditing, monitoring, metering, and billing information will be gathered and used for billing the clients on a usage basis and will be tied to the reporting and billing systems.

While the invention has been described in tennis of a single preferred embodiment, those skilled in the art will recognize that the invention can be practiced with modification within the spirit and scope of the appended claims.

1. A business method allowing a Reference Data Facility (RDF) to provide high quality reference data to customers comprising the steps of:
establishing independent contractual an arrangements or subscriptions between multiple customers and multiple data vendors,
receiving by the RDF value streams from said multiple data vendors,
validating by the RDF data received in the value streams,
determining by the RDF a Best Known Value (BKV) for the validated data based on all vendor-supplied and publicly-available data available to the RDF,
determining by the RDF a Best Known Value Available (BKVA) for each customer based on the independent contractual arrangements or subscriptions that entitle the customers to receive values from all, or some subset, of the data vendors,
delivering by the RDF reference data based on the determined BKVA to said multiple customers, and
insuring by the RDF that no customer receives data or benefits from the knowledge of data content from a vendor with whom they do not have a contractual arrangement or to whose data they are otherwise not entitled.

2. The business method recited in claim 1, wherein customers subscribe to different sets of data vendors.

3. The business method recited in claim 2, wherein the Reference Data Facility (RDF) computes a Best Known Value Available (BKVA) for some selected combinations of data to which a customer is entitled.

4. The business method recited in claim 3, wherein the Reference Data Facility (RDF) offers its customers an option to compute the Best Known Value Available (BKVA) for specified subsets of the data vendors supplying data to the RDF and to which the customer is entitled.

5. The business method recited in claim 1, wherein each value stream received from a data vendor is individually checked and improved by automatic or manual data validation and completeness, range, volatility, and similar checks as well as validation with respect to publicly available information, including original source documents, notifications, news events and other available information to improve the quality of this stream.

6. The business method recited in claim 5, wherein each value stream received from a data vendor is normalized by some combination of automatic and manual processing to allow comparison with corresponding values from other data vendors and storage in a database of reference values.

7. The business method recited in claim 6, wherein the Reference Data Facility (RDF) provides the high quality reference data by adding to the quality of the data provided by said multiple data vendors.

8. The business method recited in claim 7, wherein the Reference Data Facility (RDF) adds to the quality of the data by returning suggestions to the data vendors.

9. The business method recited in claim 7, wherein the Reference Data Facility (RDF) adds to the quality of the data by returning suggestions to the data vendors, correcting data in error, and delivering corrected data in quality-assured streams from which each vendor which that customer is entitled to receive.

10. The business method recited in claim 7, wherein the Reference Data Facility (RDF) adds to the quality of the data by making available to each customer a stream of Best Known Value Available (BKVA) values in addition to the quality assured streams from each vendor that customer is entitled to receive.

11. The business method recited in claim 7, wherein the Reference Data Facility (RDF) provides an added service of correcting data the RDF determines to be in error and sending the corrected data to its customers as well as reporting the corrections to the vendors providing incorrect data.

12. The business method recited in claim 1, wherein customer specific data formatting, delivery scheduling, filtering, routing and protocol requirements are provided as part of the process of delivering the reference data to multiple customers.

13. The business method recited in claim 1, wherein there is a persistent reference data store in which quality-assured reference values from each data vendor are stored along with information private to the reference data service about the ideal value, the Best Known Value (BKV), for each reference entity at each point in time.

14. The business method recited in claim 1, wherein reference values are delivered to customers in a way which hides whether a delivered value is a Best Known Value (BKV) known to the Reference Data Facility (RDF) or some other value acceptable to the customer based on information to which the customer is entitled so that customers receive only information to which they are entitled from the RDF.

15. The business method recited in claim 14, wherein a value of reference data delivered to a customer is further enhanced by flagging the value as delivered to denote such conditions as “questionable value undergoing further validation”, “no reliable value available”, and supplying an alternate value.

16. The business method recited in claim 14, wherein each reference entity value delivered to a customer is annotated with full source information specifying which original data records from which vendors, available to that customer, are valid entitled sources of the provided value.

17. The business method recited in claim 1, wherein the reference data includes reference domains of financial instrument or product data, counterparty or customer (account) data, and corporate actions notifications.

18. The business method recited in claim 1, wherein data vendors license different subsets of their data to different customers and the customers partition the reference entities to express which source the customers would prefer to use from among the quality-assured vendor data streams to which they are entitled for each reference entity.

19. The business method recited in claim 18, wherein periodic objective and data vendor neutral reports are provided to customers on the accuracy of the vendors for each category of reference data as identified in the partitioning of the reference entities.

20. The business method recited in claim 1, wherein the reference service is provided globally, using multiple delivery points, manual expertise in reference data quality assurance at different geographic locations, and high availability through the use of multiple geographically dispersed locations and time zones for the reference data service and its reference data stores.

21. The business method recited in claim 1, wherein customers specify rules for sub-setting, filtering, and transforming the data to be delivered to them.

22. The business method recited in claim 1, wherein the historical BKVs are retained and made available to customers.

23. The business method recited in claim 1, wherein a customer's historical BKVA can be derived and made available to customers.

24. The business method recited in claim 1, wherein the data received from vendors is made available in both corrected and uncorrected form to the customers who subscribe to the vendors' data.

25. The business method recited in claim 1, wherein the historical data received from vendors is made available in both corrected and uncorrected form to the customers who subscribe to the vendors' data.

26. The business method recited in claim 1, wherein partitioning is the basis for separately delivering subsets of data items to which customers are entitled.

27. The business method recited in claim 1, wherein the customer defines customer-specific algorithms which in all circumstances will generate a value which the customer is entitled to receive for any reference entity whose value the customer can request.

28. The business method recited in claim 27, wherein the customer-specific algorithms are segregated by customer.

29. The business method recited in claim 1, wherein auditing, monitoring, metering, and billing information are gathered and used for billing clients on a usage basis and are tied to reporting and billing systems.
